(19) United States
(12) Patent Application Publication
(10) Pub. No.: US 2015/0183330 A1
(43) Pub. Date: Jul. 2, 2015

(54) MODULAR RECONFIGURABLE MEDIUM VOLTAGE TRANSFORMER FOR DATA CENTERS, VOLT/VAR CONTROL, AC AND DC CHARGING, AND VEHICLE-TO-GRID APPLICATIONS

(71) Applicant: Electric Power Research Institute, Inc., Charlotte, NC (US)

(72) Inventors: Satish Rajagopalan, Knoxville, TN (US); Arindam Maitra, Charlotte, NC (US); Jih-Sheng Lai, Blacksburg, VA (US); Mark Duvall, Palo Alto, CA (US); Mark McGranaghan, Knoxville, TN (US)

(73) Assignee: Electric Power Research Institute, Inc., Charlotte, NC (US)

(21) Appl. No.: 14/143,081

(22) Filed: Dec. 30, 2013

(51) Int. Cl. B60L 11/18; H02J 3/00

(52) U.S. Cl. CPC B60L 11/1812; H02J 3/00; B60L 2230/16; B60L 2210/10; B60L 2210/30; B60L 2210/40

(57) ABSTRACT

A modular reconfigurable medium voltage transformer configured for data centers, VOLT/VAR control, AC and DC charging, and vehicle-to-grid applications is disclosed. The modular reconfigurable transformer includes a plurality of modules configured to be connected to or disconnected from each other to provide multiple transformer configurations. Each of the modules are configured for bi-directional or uni-directional power flow to allow the transformer to provide power from a power source to an application or from the application back to the power source

### BACKGROUND OF THE INVENTION

This application relates to medium voltage transformers and, more particularly, to modular reconfigurable medium voltage transformers configured for data centers, VOLT/VAR control, AC and DC charging, and vehicle-to-grid applications.

In the past data centers have been fed from 480 Vac voltage that is obtained by stepping down medium voltage to 480 Vac using a 60 Hz conventional distribution transformer. Additional power conversions follow before the AC voltage is converted to a suitable DC voltage for server equipment. Similarly, electric vehicle AC and DC charging has been provided from low voltage AC (120 Vac, 240 Vac, 480 Vac) that is again obtained by stepping down from medium voltage using a 60 Hz conventional transformer followed by electronics to do the actual charging.

However, these conventional transformers have created a significant barrier towards widespread adoption of these technologies due to large installation costs, large footprint, inherently low efficiencies (<90%) due to being low voltage fed systems, and limited functionality such as volt/var control and sending power from an electric vehicle back to the grid (Vehicle-to-Grid).

As a result of the deficiencies of conventional transformers, new innovative solutions are needed to reduce costs, reduce the size and weight of magnetic components, provide distribution automation and monitoring to improve reliability, provide adaptability for new service requirements, and meet customers' power quality and reliability requirements.

### BRIEF SUMMARY OF THE INVENTION

These and other shortcomings of the prior art are addressed by the present invention, which provides an advanced multi-functional all-electronic modular medium voltage transformer system that can be configured for use in multiple applications while reducing costs and providing distribution automation and monitoring.

According to one aspect of the invention, a solid-state modular reconfigurable transformer includes a plurality of modules configured to be connected to or disconnected from each other to provide multiple transformer configurations. Each of the modules are configured for bi-directional or uni-directional power flow to allow the transformer to provide power from a power source to an application or from the application back to the power source.

According to another aspect of the invention, a modular reconfigurable medium voltage transformer includes a plurality of modules configured to be connected to or disconnected from each other. The modules include an AC-DC converter module with a switching active power front-end converter configured to convert medium voltage AC into low voltage DC; a DC-DC converter module configured to step down low voltage DC from the AC-DC converter into lower voltages; a multiport switching DC-DC power converter configured to take low voltage DC from the AC-DC converter and convert it into a DC voltage suitable for fast charging electric vehicles; and a low voltage switching DC to AC power converter configured to output split phase 120 Vac/240 Vac (Level 1 and 2 charging) with neutral suitable for powering residential homes or Levels 1 and 2 vehicle charging. The transformer may take on a plurality of configurations to provide a desired voltage, AC or DC, by connecting pre-determined modules within the transformer.

### BRIEF DESCRIPTION OF THE INVENTION

The subject matter that is regarded as the invention may be best understood by reference to the following description taken in conjunction with the accompanying drawing figures in which:

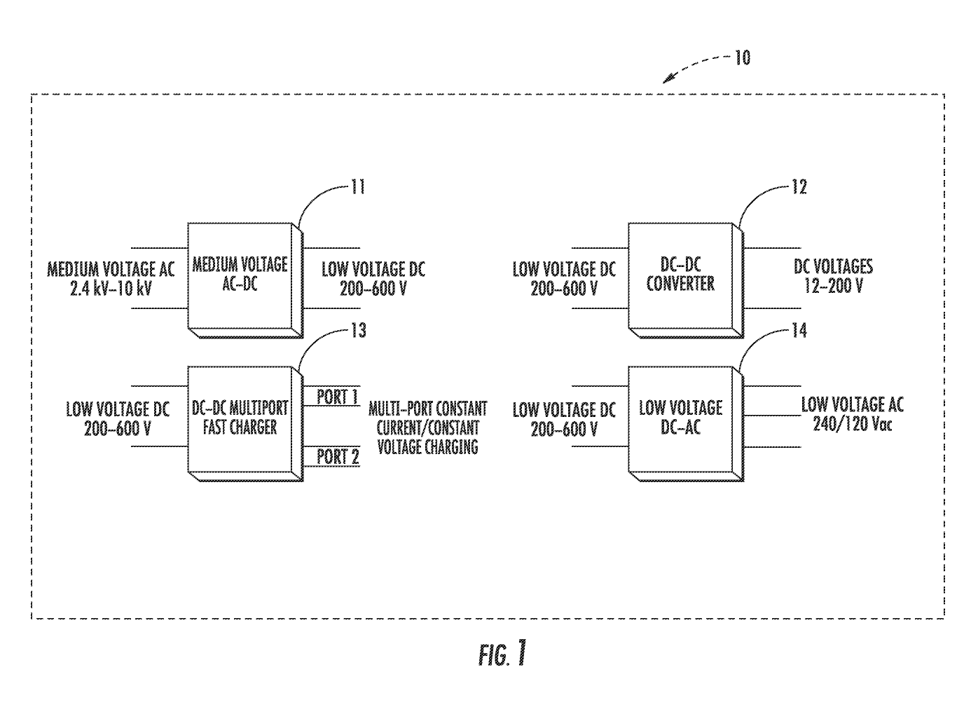

FIG. 1 shows a modular reconfigurable transformer according to an embodiment of the invention;

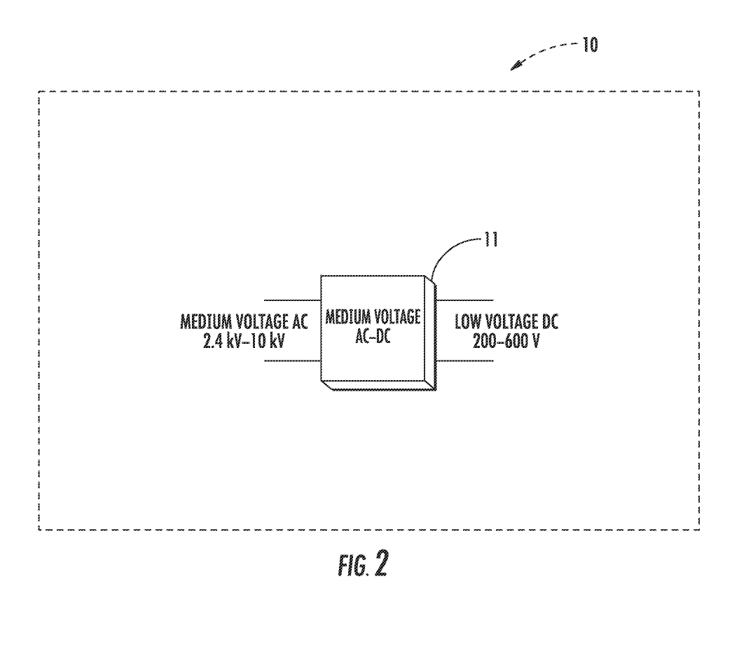

FIG. 2 shows the transformer of FIG. 1 in a first configuration;

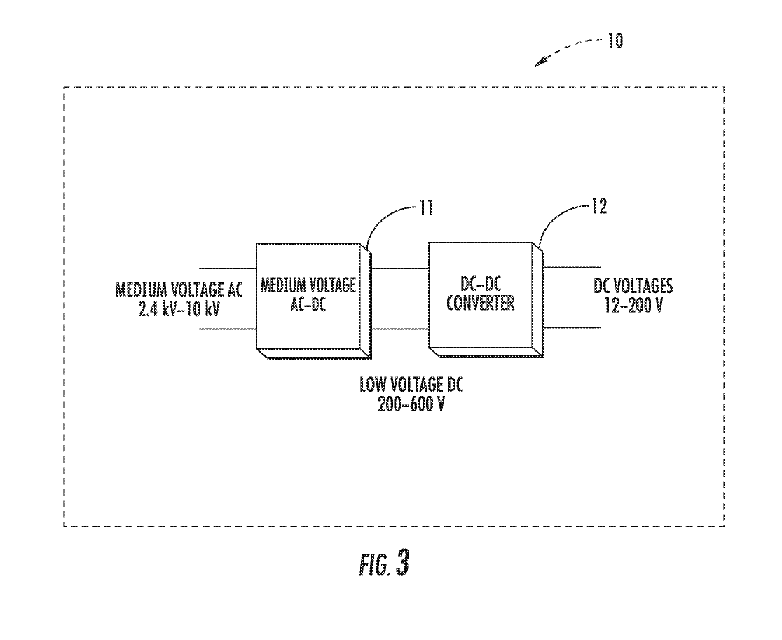

FIG. 3 shows the transformer of FIG. 1 in a second configuration;

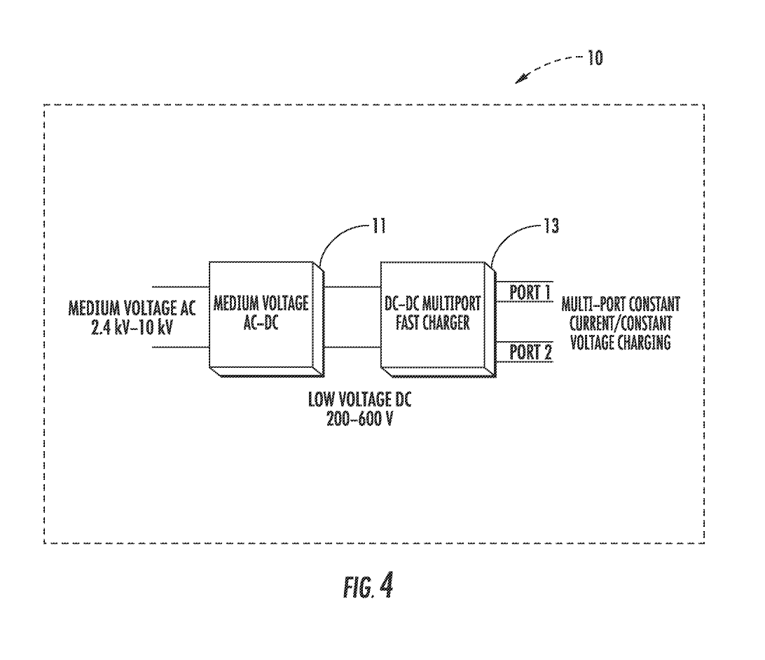

FIG. 4 shows the transformer of FIG. 1 in a third configuration;

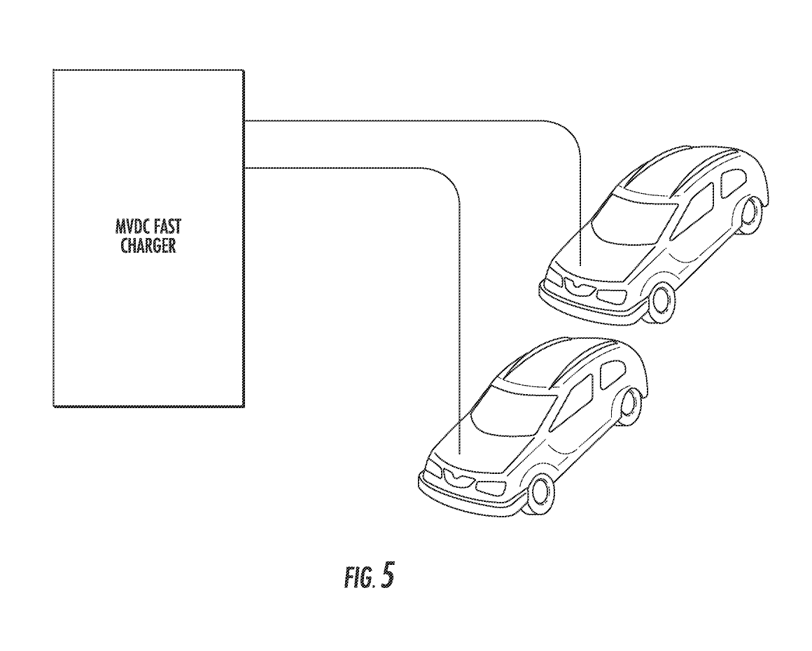

FIG. 5 shows a first approach of using the transformer of FIG. 4;

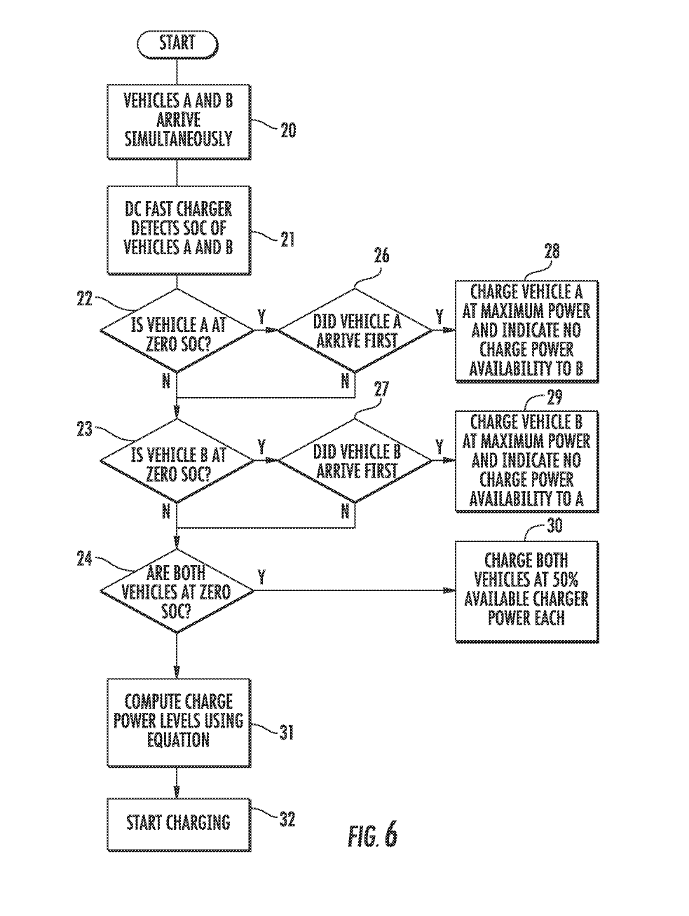

FIG. 6 is a flow diagram of the approach of FIG. 5;

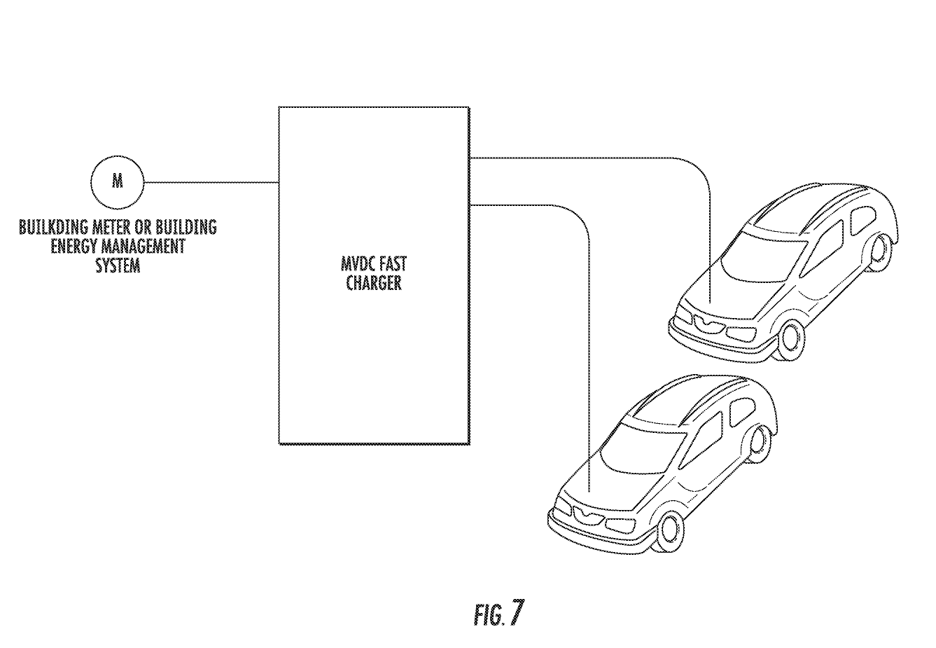

FIG. 7 shows a second approach of using the transformer of FIG. 4;

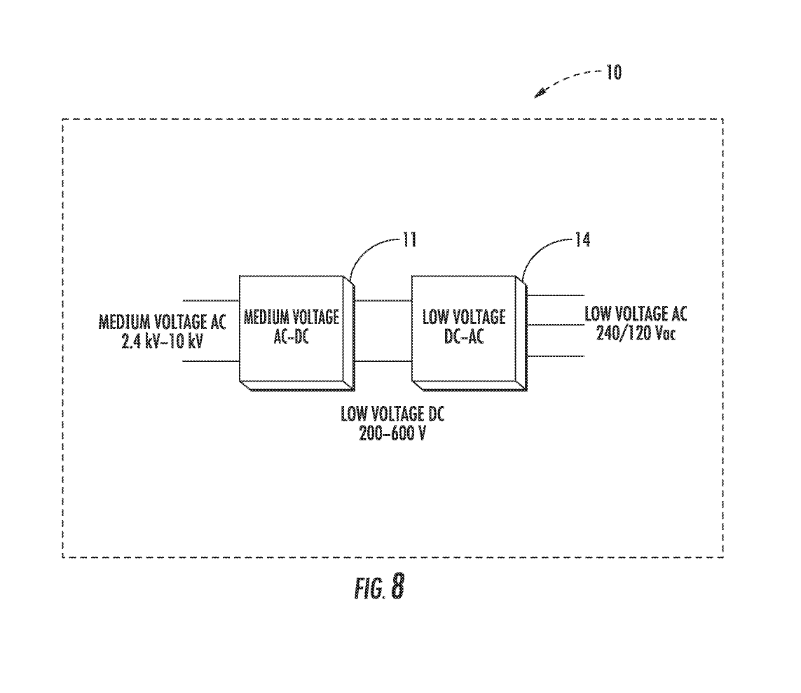

FIG. 8 shows the transformer of FIG. 1 in a fourth configuration;

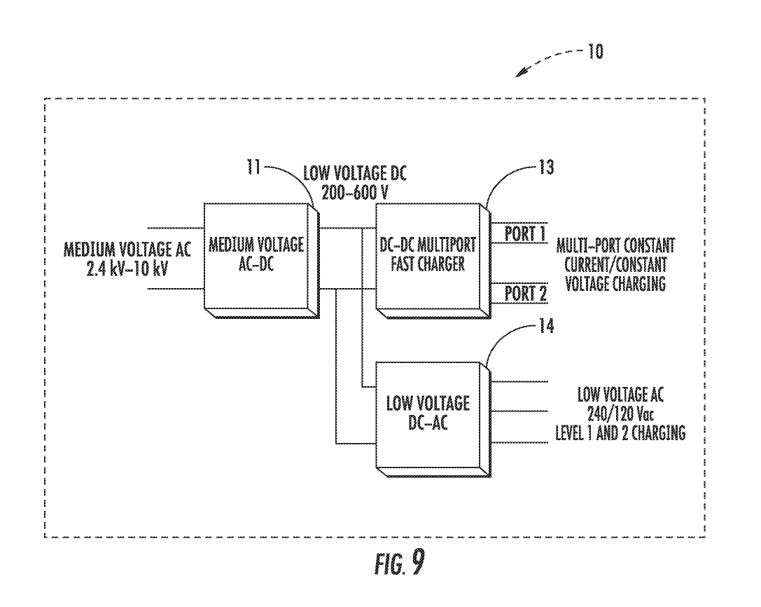

FIG. 9 shows the transformer of FIG. 1 in a fifth configuration;

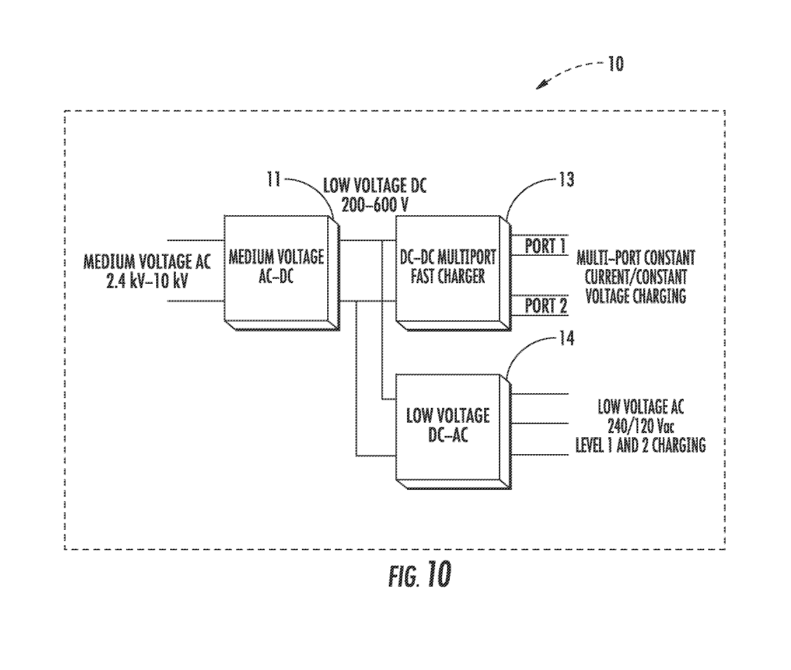

FIG. 10 shows the transformer of FIG. 1 in a sixth configuration;

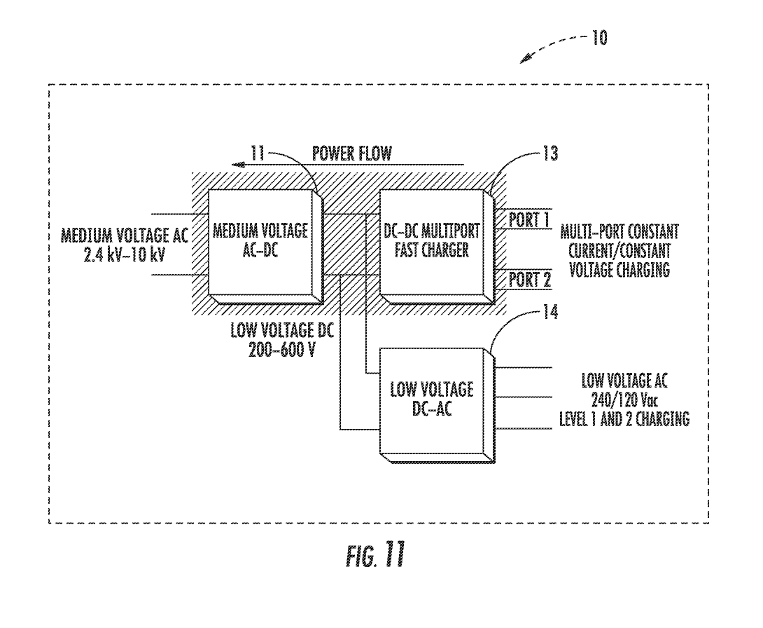

FIG. 11 shows power flow in mode 1 of the transformer of FIG. 10;

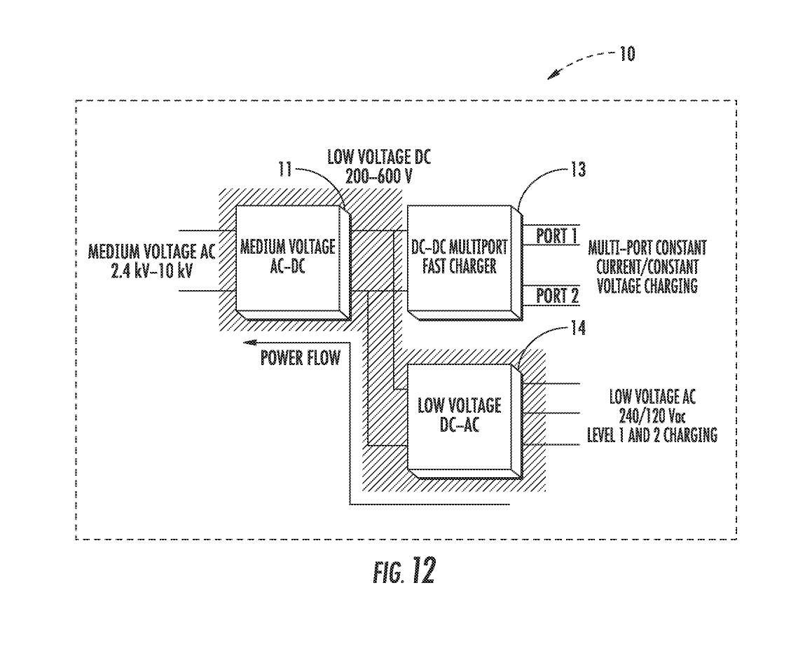

FIG. 12 shows power flow in mode 2 of the transformer of FIG. 10; and

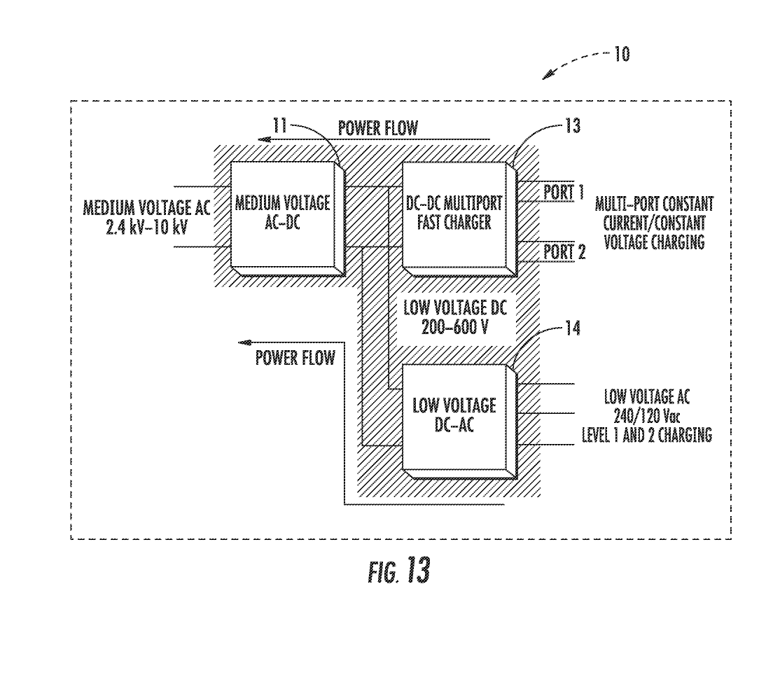

FIG. 13 shows power flow in mode 3 of the transformer of FIG. 10.

### DETAILED DESCRIPTION OF THE INVENTION

Referring to the drawings, wherein identical numerals indicate the same elements throughout the figures, FIG. 1, depicts a medium voltage transformer having a plurality of reconfigurable modules according to an embodiment of the invention and shown generally at reference numeral 10. In general, the transformer 10 is an advanced multi-functional all-electronic modular reconfigurable medium voltage transformer that can be configured for multiple applications, thereby providing flexibility, control, and adaptability to new service requirements.

The modular re-configurable medium voltage transformer 10 includes multiple modules 11-14 that can be quickly rearranged to provide any functionality. The transformer 10 is an all solid-state system that converts medium voltage directly to either low voltage DC or low voltage AC as needed. Moreover, the transformer 10 enables power flow in either direction. As such, the transformer 10 can perform advanced functions such as multi-port AC or DC vehicle fast charging, volt/var control, direct DC to power data centers without an AC feed, and vehicle-to-grid power transfer.

The four modules 11-14 will now be described. Module 11 is an all-power electronic (solid-state) converter that coverts medium voltage AC into low voltage DC. The power converter can be bi-directional or uni-directional and includes a switching active power front-end converter. The active power front-end converter may use hard-switched or soft switched topology.

Module 12 is a DC-DC converter module that can step down the low voltage DC from Module 11 into further low voltages that may be suitable for datacenter applications.

Module 13 is a multiport switching DC-DC power converter that takes the low voltage DC from Module 11 and coverts it into another DC voltage suitable for fast charging electric vehicles. This converter can also be bi-directional or uni-directional incorporates all necessary controls that will allow charging (namely constant current and constant voltage controls).

Module 14 is a low voltage switching DC to AC power converter. This module 14 can put out split phase 120 Vac/240 Vac (Level 1 and 2 charging) with neutral suitable for powering residential homes or Levels 1 and 2 vehicle charging. This power converter can also be either bi-directional or uni-directional.

Several configurations and operational modes are possible and presented herewith.

Transformer Configuration 1 (FIG. 2): In this configuration, the transformer 10 provides low voltage (LV) DC for data centers and only utilizes module 11. Module 11 is a Medium Voltage (MV) solid-state AC/DC converter that coverts medium voltage AC into low voltage DC. The power converter can be bi-directional or uni-directional and includes a switching active power front-end converter. This module 11 is used to supply DC datacenter backbones that operate at 380 Vdc.

Transformer Configuration 2 (FIG. 3): In configuration 2, the transformer 10 provides low voltage DC port access for data centers by utilizing modules 11 and 12. Modules 11 and 12 are combined to obtain lower voltages all the way down to 12 Vdc for use in power server racks, for example.

Transformer Configuration 3 (FIGS. 4-7): In this configuration, transformer 10 provides a multi-port medium voltage DC fast charger. As shown, modules 11 and 13 are used to provide DC fast charging capability. Two possible approaches are presented in this configuration.
Approach 1: Multi-port sharing based on vehicle state-of-charge (FIG. 5). In this approach (See FIG. 6), two vehicles are charged simultaneously based on their battery state of charge (SOC). Let us assume vehicle A and vehicle B arrives at the same time, Block 20. The dc fast charger would have two charge connectors, one of each would be connected to each vehicle. The DC fast charger would read the SOC, Blocks 21-24, of each vehicle battery and allocate a charge power level to each vehicle, Blocks 26-30. This charge power level would be a function of SOC and can be computed, Block 31, in many ways—a simple way would be as follows:
   Charge Power Level A: Total available charger rated power×(1−(SOCA/(SOCA+SOCB)))
   Charge Power Level B: Total available charger rated power×(1−(SOCB/(SOC A+SOCB)))

With the charge power levels computed, charging is started, Block 32. The charge algorithm is shown in FIG. 6.

Example: Let us assume total available charger rated power is 50 kW. Vehicle A arrives with 0.7 SOC and Vehicle B arrives with 0.5 SOC. Each vehicle would then be allotted a charge power level of:

Charge Power Level A: 50*(1−(0.7/1.2))=20.8 kW

Charge Power Level B: 50*(1−(0.5/1.2))=29.2 kW

This would ensure a fair allocation of charger power levels.
Approach 2: Multi-port sharing based on vehicle state-of-charge tied in with build energy management system or building meter (FIG. 7). This approach is similar to approach 1, except that the DC fast charger also reads the instantaneous building power to which it is connected and decreases the available charger power by that amount. The DC fast charger may be connected to a building using a building energy management system or a direct meter.

Example: Let us say we have a DC fast charger of rated power P connected to a building load B. The charger is able to read in the building load.

Total available charger rated power=P−B
Charge Power Level A: Total available charger rated power×(1−(SOCA/(SOC A+SOCB)))
Charge Power Level B: Total available charger rated power×(1−(SOCB/(SOC A+SOCB)))

Example: Let us assume total charger rated power is 50 kW and it is connected to a building via a building energy management system. Let us further assume that the building consumes 10 kW. Vehicle A arrives with 0.7 SOC and Vehicle B arrives with 0.5 SOC.

The total available charger rated power=50−10=40 kW

Each vehicle would then be allotted a charge power level of:

Charge Power Level A: 40*(1−(0.7/1.2))=16.7 kW

Charge Power Level B: 40*(1−(0.5/1.2))=23.3 kW

This would ensure a fair allocation of charger power levels.

Transformer Configuration 4 (FIG. 8): In configuration 4, the transformer 10 provides a volt regulator, Volt/Var, & level 1/2 charger. In this configuration, modules 11 and 14 are utilized to provide the following three functions:
Dynamically controllable voltage regulator for improved system wide voltage optimization and support.
Serve as smart nodes for volt/var support at multiple points along the distribution system.
240/120 Vac SAE Level 1 or 2 charging as well as supporting residential loads.

Transformer Configuration 5 (FIG. 9): In configuration 5, transformer 10 provides a combined multi-port DC fast charger and level 1/2 charger. In this configuration, modules 11, 13, and 14 are used to provide both DC fast charging and 240/120 Vac SAE Level 1 or 2 charging.

Transformer Configuration 6 (FIGS. 10-13): In this configuration, transformer 10 provides a vehicle-to-grid (V2G) option. As shown, modules 11, 13, and 14 are used to provide DC fast charging and 240/120 Vac SAE Level 1 or 2 Charging, as well as sending power from the vehicle battery back to grid. Several V2G modes are possible and are shown in FIGS. 11-13. All of the modules 11-14 may be bi-directional power converters.
Mode 1 (FIG. 11): In mode 1, power flows from the vehicle battery through module 13 to module 11 and back to the grid.
Mode 2 (FIG. 12): In mode 2, power flows from the vehicle battery through module 14 through module 11 and back to the grid.
Mode 3 (FIG. 13): In mode 3, power flows from vehicle batteries through both module 13 and module 14 and then through module 11 and back to the grid.

The foregoing has described a modular reconfigurable medium voltage transformer. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A solid-state modular reconfigurable transformer, comprising a plurality of modules configured to be connected to or disconnected from each other to provide multiple transformer configurations, wherein each of the modules are configured for bi-directional or uni-directional power flow to allow the transformer to provide power from a power source to an application or from the application back to the power source.

2. The transformer according to claim 1, wherein the transformer includes four modules.

3. The transformer according to claim 1, wherein the plurality of modules includes:
(a) an AC-DC converter module with a switching active power front-end converter configured to convert medium voltage AC into low voltage DC;
(b) a DC-DC converter module configured to step down low voltage DC from the AC-DC converter into lower voltages that are suitable for datacenter applications;
(c) a multiport switching DC-DC power converter configured to take low voltage DC from the AC-DC converter and convert it into a DC voltage suitable for fast charging electric vehicles; and
(d) a low voltage switching DC to AC power converter configured to output split phase 120 Vac/240 Vac (Level 1 and 2 charging) with neutral suitable for powering residential homes or Levels 1 and 2 vehicle charging.

4. The transformer according to claim 1, wherein the active power front-end converter is configured to use hard-switched or soft switched topologies.

5. The transformer according to claim 1, wherein the multiport switching DC-DC converter includes controls configured to allow constant current and constant voltage charging.

6. A modular reconfigurable medium voltage transformer, comprising:
(a) a plurality of modules configured to be connected to or disconnected from each other, the modules include:
(i) an AC-DC converter module with a switching active power front-end converter configured to convert medium voltage AC into low voltage DC;
(ii) a DC-DC converter module configured to step down low voltage DC from the AC-DC converter into lower voltages;
(iii) a multiport switching DC-DC power converter configured to take low voltage DC from the AC-DC converter and convert it into a DC voltage suitable for fast charging electric vehicles; and
(iv) a low voltage switching DC to AC power converter configured to output split phase 120 Vac/240 Vac (Level 1 and 2 charging) with neutral suitable for powering residential homes or Levels 1 and 2 vehicle charging; and
(b) wherein the transformer may take on a plurality of configurations to provide a desired voltage, AC or DC, by connecting pre-determined modules within the transformer.

7. The transformer according to claim 6, wherein a first transformer configuration includes connecting the AC-DC converter module to the DC-DC converter module to provide low voltage DC port access for data centers.

8. The transformer according to claim 6, wherein a second transformer configuration includes connecting the AC-DC converter module to the multiport switching DC-DC power converter to provide DC fast charging.

9. The transformer according to claim 6, wherein a third transformer configuration includes connecting the AC-DC converter module to the low voltage switching DC to AC power converter to provide a volt regulator, Volt/Var, & level 1/2 charger.

10. The transformer according to claim 6, wherein a fourth transformer configuration includes connecting the AC-DC converter module to the multiport switching DC-DC power converter and the low voltage switching DC to AC power converter to provide:
(a) DC fast charging;
(b) 240/120 Vac SAE Level 1 or 2 charging; and
(c) vehicle-to-grid operation where power from a vehicle battery is sent back to a power grid.
